(19) United States
(12) Patent Application Publication
(10) Pub. No.: US 2016/0021884 A1
(43) Pub. Date: Jan. 28, 2016

(54) STABLE SOLUTIONS OF 1,2-BENZISOTHIAZOLIN-3-ONE

(71) Applicant: TITAN CHEMICALS LIMITED, Road Town (VG)

(72) Inventors: Carsten BERG, Borre (DK); Sangita Singh, Warlingham (GB)

(21) Appl. No.: 14/444,196

(22) Filed: Jul. 28, 2014

(51) Int. Cl. A01N 43/80; A01N 25/22

(52) U.S. Cl. CPC A01N 43/80; A01N 25/22

(57) ABSTRACT

A composition comprises 5-15 wt % of the potassium salt of 1,2-benzisothiazolin-3-one (K-BIT) calculated as 1,2-benzisothiazolin-3-one (BIT), 2-12 wt % of a nonionic surfactant, and at least 70 wt %. The presence of the nonionic surfactant stabilizes an aqueous solution of the composition at a temperature of −5° C. A method of stabilizing an aqueous solution comprising 5-15 wt % of the potassium salt of 1,2-benzisothiazolin-3-one (K-BIT) calculated as 1,2-benzisothiazolin-3-one (BIT) and at least 70 wt % water at a temperature of −5° C., includes the step of incorporating within the aqueous solution an amount of the nonionic surfactant so that the aqueous solution has 2-12 wt % of the nonionic surfactant.

### FIELD OF THE INVENTION

This invention relates to biocides containing salts of 1,2-benzisothiazolin-3-one. 1,2-benzisothiazolin-3-one, sometimes referred to hereinafter as BIT, is a well-known industrial biocide (CAS# 2634-33-5) which is efficient in protecting aqueous media against microbial attack. It is effective as a bactericide and suited to various industrial applications such as metal working fluids, cooling tower water, emulsions, plastic film, paint, building materials, stucco, concrete, caulks, sealants, joints, adhesives, leather, wood, inks, pigment dispersions, drilling mud, clay slurries, agricultural applications, seed coatings, pesticide compositions, toiletry, household, cleaning, disinfecting, enzyme formulations, laundry products, and the like.

### BACKGROUND ART

It is advantageous to provide BIT as a highly aqueous solution for its intended use in the various above specified fields, but BIT itself is not very water soluble. While it can be used either as a suspension or as a solution in an organic solvent neither option is especially favourable: in the case of suspensions settling can occur leading to difficulties in dosage, whilst the disadvantages of using solutions based on volatile organic solvents are well known.

BIT is often used in the form of a salt, some of which are water soluble. Alkali metal salts are usually preferred. U.S. Pat. No. 4,871,754 discloses that the lithium salt of BIT can form purely aqueous solutions which are stable at 5° C. for 4 weeks, but purely aqueous solutions of most commercially used BIT salts crystallise at relatively high temperatures and are therefore not useful at low temperatures. This is typically addressed by stabilising the solutions through the addition of organic compounds such as glycols, for example propylene glycols, polyethylene glycols, polyglycols, glycerols etc. Thus BIT is now frequently formulated as an alkali metal salt in one or more water miscible solvents such as dipropylene glycol. Such formulations are stable solutions which withstand freeze-thaw temperature cycling, and even if frozen recover on warming to regenerate a stable solution, by which is meant a solution which remains free of solid deposits. Formulations of this type may contain for example 20% BIT and 65% dipropylene glycol, the remainder being water, where the BIT has been converted to sodium-BIT by reacting 1.1 moles of sodium hydroxide with 1 mole of BIT. U.S. Pat. No. 7,666,887 discloses stable BIT formulations comprising 0.1-30% (eg 20 wt %) of BIT, 20-90% (eg 70 wt %) of polyethylene glycol 400, up to 3 wt % (eg 2 wt %) of NaOH, KOH or LiOH, and up to 15% (eg 8 wt %) of water. WO 2009/016252 discloses BIT formulations comprising 5-50 wt % BIT and 30-70 wt % mono-ethylene glycol, where the BIT has been reacted with up to 1.1 moles of potassium hydroxide per mole of BIT.

Alternative formulations include those disclosed for example in U.S. Pat. No. 4,923,887, which claims liquid formulations comprising 14-45 wt % of a substantially equimolar mixture of BIT and an ethoxylated (coconut-alkyl)amine with a degree of ethoxylation of 2, 10-35 wt % of a water-miscible organic solvent such as a glycol, and 20-55 wt % water as well as optional other additives. This document states that the mixture of BIT and ethoxylated amine is synergistic and has superior biological activity compared with either component alone.

Although organic solvents such as glycols are routinely used to stabilise aqueous solutions of BIT or BIT salts, for alkali metal salts at least they only provide guaranteed stability down to a temperature of about 0° C. WO 2012/158425 discloses aqueous solutions of BIT salts which are free of organic solvents, and which comprise 0.1-5 wt % of a chelating agent in addition to the BIT, salt and water. These compositions may optionally additionally comprise a surfactant, which is preferably an anionic surfactant, although nonionic surfactants may also be used. Sulfosuccinate (anionic) surfactants are stated to be most preferred because of their properties such as foaming, strong wetting, emulsifying and solublizing properties, surface activity, effective reduction of surface tension, biodegradability, extreme mildness and low critical micelle concentration (CMC).

### SUMMARY OF THE INVENTION

We have found that it is possible to make an aqueous solution of the potassium salt of BIT (K-BIT) which is stable down to −5° C. by incorporating in the composition a nonionic surfactant.

Accordingly in a first aspect the invention provides an aqueous solution comprising 5-15 wt % of the potassium salt of 1,2-benzisothiazolin-3-one (K-BIT) calculated as 1,2-benzisothiazolin-3-one (BIT), 2-12 wt % of a nonionic surfactant, and at least 60 wt % water.

A further aspect of the invention provides a method of stabilising an aqueous solution comprising 5-15 wt % of the potassium salt of 1,2-benzisothiazolin-3-one (K-BIT) calculated as 1,2-benzisothiazolin-3-one (BIT) and at least 70 wt % water at a temperature of −5° C., comprising the step of incorporating within the solution 2-12 wt % of a nonionic surfactant.

A still further aspect of the invention is the use of a nonionic surfactant, preferably 2-12 wt % thereof, to stabilise at a temperature of −5° C. an aqueous solution comprising 5-15 wt % of the potassium salt of 1,2-benzisothiazolin-3-one (K-BIT) calculated as 1,2-benzisothiazolin-3-one (BIT) and at least 70 wt % water.

Embodiments and features described below apply to all of the above aspects of the invention.

### DETAILED DESCRIPTION OF THE INVENTION

Stabilising at a temperature of −5° C. means obtaining a solution which is stable at −5° C. By “stable” is meant that a solution of K-BIT maintained at a temperature of −5° C. remains free of solid deposits for at least 1 hour following seeding with a crystal of K-BIT.

The aqueous solution of K-BIT preferably comprises 9-11 wt % of K-BIT calculated as BIT.

The aqueous solution of K-BIT preferably comprises 2-10 wt % of a nonionic surfactant, more preferably 2-8 wt % and most preferably 3-7 wt %.

The nonionic surfactant is preferably an ethoxylated fatty amine of the formula R-NR¹R² where R is a C₈-C₂₂ alkyl or alkenyl group, R¹ is —(CH₂—CH₂—O—)ₘH and R² is —(CH₂-CH₂—O—)ₙH, where m+n, which is also known as the degree of ethoxylation, is from 2 to 30.

The ethoxylated fatty amines are preferably employed in the form of their commercially available mixtures. They are prepared by reaction of fatty amines of the formula RNH₂, for example (coconut alkyl)-amine, stearylamine, oleylamine or (tallow alkyl)-amine, with ethylene oxide, for example with degrees of ethoxylation (=m+n) of 2 to 30, and are mixtures of components having different R groups. In the preferred compositions, the degree of ethoxylation (=m+n) is from 2 to 15. In the formula above n is from 1 to 30, preferably 1 to 10, and especially preferably 1 or 2, and m is from 0 to 15, preferably 0 to 5, and especially preferably either 0 or 1.

Ethoxylated cocoamine (also known as ethoxylated (coconut alkyl)-amine), oleylamine, stearylamine and (tallow alkyl)-amine all with a degree of ethoxylation of 2 are particularly preferred. Ethoxylated cocoamines with a degree of ethoxylation of 2 are commercially available, for instance from Clariant under the trade name Genamin®-C-020. The coconut alkyl in such ethoxylated cocoamines is a mixture of alkyl groups having a chain length for R in the formula R-NR¹R² of C₈ to C₁₈.

Examples of particularly preferred ethoxylated cocoamines are an ethoxylated cocoamine having a degree of ethoxylation of 15, available under the trade name Genamin®-C150, and an ethoxylated cocoamine having a degree of ethoxylation of 2, available under the trade name Blagsurf CA02.

The pH of the aqueous solution of K-BIT is preferably from 9 to 12, most preferably 10 or 11.

As previously mentioned, it is known to add water-miscible organic solvents such as glycols to aqueous BIT salt solutions in order to improve their stability. The aqueous solutions of the present invention may optionally additionally contain a water miscible-organic solvent. Examples of such water-miscible organic solvents include aliphatic alcohols having 1 to 4 carbon atoms such as ethanol and isopropanol, glycols such as ethylene glycol, diethylene glycol, triethylene glycol, tetraethylene glycol, pentaethylene glycol, hexaethylene glycol, heptaethylene glycol, octaethylene glycol, propylene glycol, dipropylene glycol, tripropylene glycol, polypropylene glycol, ethylene propylene glycol, polyethylene polypropylene glycol, ethyl glycol, propyl glycol, isopropyl glycol, n-butyl glycol, i-butyl glycol, t-butyl glycol, methyl diglycol, methyl polyglycol, ethyl diglycol, propyl diglycol, butyl diglycol, ethyl triglycol, propyl triglycol, butyl triglycol, butyl polyglycol, propylene glycol monoethyl ether, propylene glycol mono-n-propyl ether, propylene glycol n-butyl ether, methyldipropylene glycol, monoethylene glycol dimethyl ether (monoglyme), diethylene glycol dimethyl ether (diglyme), triethylene glycol dimethyl ether (triglyme), triethylene glycol diethyl ether, tetraethylene glycol dimethyl ether (tetraglyme), propylene glycol phenyl ether, polyethylene glycol dibutyl ether; polyethylene glycol diallyl ether; polyethylene glycol allylmethyl ether; polyalkylene glycol allylmethyl ether glycol esters such as 2,2,4-trimethylpentanediol monoisobutyrate, polyethylene glycol, polypropylene glycol, N,N-dimethylformamide and mixtures thereof.

The amount of any water-miscible organic solvent, if present in the aqueous solutions of the present invention, is preferably no more than 20 wt %, more preferably 5-15 wt %.

The aqueous solution of K-BIT can also contain other customary constituents known as additives to those skilled in the art in the field of biocides. These include thickening agents, defoaming agents, substances to adjust the pH value, perfumes, dispersing agents, and coloring substances.

The aqueous solution of K-BIT can be used in many different fields. It is suitable, for example, for use in paints, plasters, lignosulfonates, chalk suspensions, adhesives, photochemicals, casein-containing products, starch-containing products, bituminous emulsions, surfactant solutions, motor fuels, cleaning agents, cosmetic products, water circulating systems, polymer dispersions, and cooling lubricants, against attack by, for example, bacteria, filamentous fungi, yeasts, and algae.

### Example 1

Preparation of potassium salt solutions of BIT and surfactant

A BIT paste (85% in water, 27.3 g, 0.153 mol) was prepared in 100 g water with stirring. KOH solution (49.5% w/w, 17.3 g, 0.153 mol) was added to the stirred mixture followed by the surfactant BlagSurf CA02 (12.5 g), which is a polyol cocoamine having a degree of ethoxylation of 2. The total weight was made up to 240 g with water and the mixture stirred to give a clear solution. The pH was measured (11.15) and adjusted to 11.0 by addition of a few drops of 10% aq HCl. The total weight was made up to 250 g with water and the solution filtered through 8 micron paper filter, to give a solution of nominal composition 9.25% BIT, 5% BlagSurf CA02.

Using the same procedure, solutions containing different surfactants and for comparison dipropylene (DPG) and tripropylene glycol (TPG), as well as a composition containing no surfactant, were also prepared.

The solutions were maintained at a specified temperature whilst subjected to continuous stirring, and seeded with a crystalline potassium salt of BIT. Stirring was then maintained at the same temperature for 1 hour, after which the appearance of each solution was assessed.

Table 1 shows the stability after 1 hour of different 9.25% BIT solutions exposed to low temperatures. In the Table below:

“Clear” =no solid deposits

“Solids” =hazy solution (due to suspended solids), or precipitate visible

“Immobile” =solution not pourable

TABLE 1

| | | Stability | Stability | Stability |
|---|---|---|---|---|
| | Additive | 0° C. | −5° C. | −10° C. |
| A | none | crystals | crystals | solids |
| B | 5% ethoxylated cocoamine | clear | clear | solids |
| | (Genamin C150) | | | |
| C | 5% polyol cocoamine (BlagSurf | clear | clear | solids |
| | CA02) | | | |
| D | 5% cocoamidopropylbetaine | solids | solids | solids |
| E | 5% sodium dodecyl | solids | immobile | immobile |
| | benzenesulfonate | | | |
| F | 5% DPG | clear | solids | solids |
| G | 5% TEG | clear | solids | solids |

Genamin ®-C150 is an ethoxylated cocoamine having a degree of ethoxylation of 15, available from Clariant.
BlagSurf CA02 is an ethoxylated cocoamine having a degree of ethoxylation of 2, available from Blagden Speciality Chemicals.

Cocoamidopropylbetaine is a zwitterionic surfactant which behaves as an anionic surfactant at a pH above 8. Sodium dodecyl benzenesulfonate is an anionic surfactant. It can be seen from the above results that only the nonionic cocoamine surfactants enable a stable solution of K-BIT to be obtained at −5° C.: with the anionic surfactants stability is not even obtained at 0° C. Addition of the glycols, as is used routinely in the prior art, provides a solution which is stable at 0° C. but not at −5° C.

1. Composition comprising 9-15 wt % of the potassium salt of 1,2-benzisothiazolin-3-one (K-BIT) calculated as 1,2-benzisothiazolin-3-one (BIT), 3-7 wt % of an ethoxylated fatty amine of the formula R-NR¹R² where R is a C₈-C₂₂ alkyl or alkenyl group, R¹ is —(CH₂—CH₂—O—)ₘH and R² is —(CH₂—CH₂—O—)ₙH, where m+n is from 2 to 30, and at least 70 wt % water.

2. A method of stabilising an aqueous solution comprising 5-15 wt % of the potassium salt of 1,2-benzisothiazolin-3-one (K-BIT) calculated as 1,2-benzisothiazolin-3-one (BIT) and at least 70 wt % water at a temperature of −5° C., comprising the step of incorporating within the aqueous solution an amount of a nonionic surfactant so that the stabilized aqueous solution contains 2-12 wt % of the nonionic surfactant.

3. The composition according to claim 1, which comprises 9-11 wt % of K-BIT calculated as BIT.

4-7. (canceled)

8. The composition according to claim 1, wherein m+n is from 2 to 15.

9. The composition according to claim 8, wherein the ethoxylated fatty amine of the formula R-NR¹R² is selected from the group consisting of ethoxylated cocoamine, oleylamine, stearylamine, and tallow alkyl-amine, all having a value of m+n of 2.

10. The composition according to claim 1, wherein the pH is from 9 to 12.

11. The method according to claim 2, which comprises 9-11 wt % of K-BIT calculated as BIT.

12. The method according to claim 2, which comprises 2-10 wt % of a nonionic surfactant.

13. The method according to claim 2, which comprises 2-8 wt % of a nonionic surfactant.

14. The method according to claim 2, which comprises 3-7 wt % of a nonionic surfactant.

15. The method according to claim 2, wherein the nonionic surfactant is an ethoxylated fatty amine of the formula R-NR¹R² where R is a C₈-C₂₂ alkyl or alkenyl group, R¹ is —(CH₂—CH₂—O—)ₘH and R² is —(CH₂—CH₂—O—)ₙH, where m+n is from 2 to 30.

16. The method according to claim 2, wherein m+n is from 2 to 15.

17. The method according to claim 2, wherein the ethoxylated fatty amine of the formula R-NR¹R² is selected from the list consisting of ethoxylated cocoamine (also known as ethoxylated (coconut alkyl)-amine), oleylamine, stearylamine and (tallow alkyl)-amine all having a value of m+n of 2.

18. The method according to claim 2, wherein the pH is from 9 to 12.
